(19) United States
(12) Patent Application Publication
(10) Pub. No.: US 2013/0087941 A1
(43) Pub. Date: Apr. 11, 2013

(54) METHOD OF PRODUCING CARBON NANOTUBE SPONGES

(71) Applicants: Shih-Chin Chang, Hsinchu City (TW); Ping-Cheng Sung, Hsinchu City (TW)

(72) Inventors: Shih-Chin Chang, Hsinchu City (TW); Ping-Cheng Sung, Hsinchu City (TW)

(73) Assignee: NATIONAL TSING HUA UNIVERSITY

(21) Appl. No.: 13/344,558

(22) Filed: Jan. 5, 2012

(30) Foreign Application Priority Data
Oct. 7, 2011 (TW) 100136442

(51) Int. Cl. B29C 35/16

(52) U.S. Cl. 264/42

(57) ABSTRACT

A kind of production method for carbon nanotube sponges which can control different hole sizes and densities, having uniform cell sizes. The formed carbon nanotube sponge has a soft, flexible and multi-holed structure. The carbon nanotubes pass through a hydrophilic acid process, mixing with different ratios of polymer materials PVA and are dispersed in the solvent. This mixed liquid is frozen under different controlled solidifying rates, forming different sized solid ice crystals having controllable particle sizes, and is vacuumized in the next step, which removes the frozen solvent through low pressure sublimation, the remains being the multi-holed carbon nanotube sponge structure. The size of the cells of the carbon nanotube sponge structure can be controlled through the freezing rate and the addition of polymers. The strength and stiffness can be controlled through the density of the carbon nanotubes and the addition of polymers.

### BACKGROUND OF THE INVENTION

1. Field of the Invention

The present invention relates to an application method of carbon nanotubes, in particular to a method of producing carbon nanotube sponges.

2. Description of the Related Art

Carbon nanotubes possess improved mechanical properties, unique electrical properties, high thermal conductivity, good chemical resistance, hydrogen adsorption and excellent field emission properties.

Because of these excellent properties, the applied fields where carbon nanotubes can be used are very wide. For example, carbon nanotubes are very lightweight, have extremely high tensile strength and elastic modulus and are predicted to be the strongest fiber; it has high flexibility, can be repeatedly bent at large angles without defects arising; because of the characteristics of the hollow capillary tubes, they can store huge amounts of hydrogen or lithium ions, and be used as fuel cells and so on.

Conventionally produced carbon nanotube sponges (Aerogels) require using expensive supercritical fluid equipment, and a longer production time, moreover previous production methods of carbon nanotube sponges have passed through a sol-gel process as well as a drying method, which utilizes surfactants (SDBS) for the production. However this method requires specialized freezing equipment to proceed with the freeze-drying production process, and the holes in the produced carbon nanotube sponges are not uniform.

Besides the above described production method of carbon nanotube sponges, there is also a conventional method which uses a bubbling method for production, but this method also results in holes which are not uniform. Furthermore, to support the skeleton the conventional method needs to pass through a thermal chemical vapor deposition method to produce the carbon nanotube sponges, and the results of the high production cost and difficulty of production are also poor.

Therefore, the applicant has focused on the shortcomings in the conventional techniques, and wishing to simplify the conventional method, with not only increased flexibility but also uniform hole sizes, as well as being able to control the size of the holes in the production process, has invented (Method of producing carbon nanotube sponges) to improve on the methods and shortcomings of the above described conventional methods.

### SUMMARY OF THE INVENTION

The purpose of the present invention is to produce carbon nanotube sponge with both increased flexibility and uniform holes, and at the same time, during the manufacturing process, the hole sizes of the carbon nanotube sponge can be controlled by appropriate adjustments of the ice crystallization temperature, the concentration of the carbon nanotubes solution and the concentration of the polymer material solution.

In order to achieve the above mentioned purpose, the present invention provides a method of producing carbon nanotube sponge, including the following steps: (a) proceeding with an acidification process for functionalizing a carbon nanotube by utilizing a mixture; (b) forming a dispersed carbon nanotube solution by adding a solvent to the carbon nanotube after the acidification process; (c) forming a polymer solution by adding a polymer into another solvent; (d) forming a blended solution by mixing the dispersed carbon nanotube solution with the polymer solution; (e) injecting the blended solution into a mold, and placing under a certain temperature for solidifying the blended solution; (f) forming a solidified carbon nanotube containing a plurality of ice crystals; (g) placing the solidified carbon nanotube in a vacuum environment at room temperature and removing a section of ice crystals through low pressure sublimation; and (h) forming a carbon nanotube sponge, wherein the carbon nanotube sponge has a multi-porous structure, and hole sizes of the carbon nanotube sponge can be controlled through adjusting the concentration of the dispersed carbon nanotube solution, the solidification rate of the blended solution and a crystallization temperature of the plurality of ice crystals, and strength and stiffness can be controlled through the density of the carbon nanotube and an addition of the polymer.

Preferably, the mixed solution in step (a) further comprises sulfuric acid and nitric acid.

Preferably, wherein the carbon nanotube in step (a) is one selected from the following groups: single-walled carbon nanotube and multi-walled carbon nanotube.

Preferably, the solvent in step (c) is toluene.

Preferably, the concentration of the polymer solution in step (c) is between 0% and 1%.

Preferably, the carbon nanotube in the blended solution in step (d) occupies a percentage by weight of 1-40 mg/mL.

Preferably, the vacuum environment in step (g) is under 0.5 atm.

Therefore, the fabrication method of carbon nanotube sponge of the present invention not only effectively reduces conventional processes, but also reduces the production costs thereof, and more particularly, the carbon nanotube sponge produced by the method of this invention has the following excellent properties:

1. low density, high flexibility and robustness 2. the cell size of the multi-porous structure can be easily controlled 3. high surface/mass ratio 4. good electrical conductivity, chemical resistance and biocompatibility 5. simple equipment and production process 6. low material cost. In the future, this invention can be further applied to composite materials, oil clean-up, the absorption of electromagnetic waves, electronic electrode and chemical devices, pressure detectors, touch panels and even the development of biological cells, etc., which applications can be described as deep and wide, and have great industrial usage value.

The invention, as well as its many advantages, may be further understood by the following detailed description and drawings in which:

### BRIEF DESCRIPTION OF THE DRAWINGS

FIG. 1 is a production flow chart showing one embodiment of the present invention.

FIG. 2 is a diagram showing one embodiment of the carbon nanotube sponge of this invention which passes through 5 repeated compressions, and shows a data map of the returned mechanical property tests.

FIG. 3 is a diagram showing one embodiment of the carbon nanotube sponge of this invention which passes through 5 repeated compressions, and shows a data map of the electrical resistance value changes obtained.

Annex 1 is a diagram showing a carbon nanotube sponge of one embodiment of the invention.

Annex 2 is a structure image showing a carbon nanotube sponge of one embodiment of the invention under an electron microscope at 200× magnification.

### DETAILED DESCRIPTION OF THE INVENTION

The technical characteristics and operation processes of the present invention will become apparent with the detailed description of preferred embodiments and the illustration of related drawings as follows.

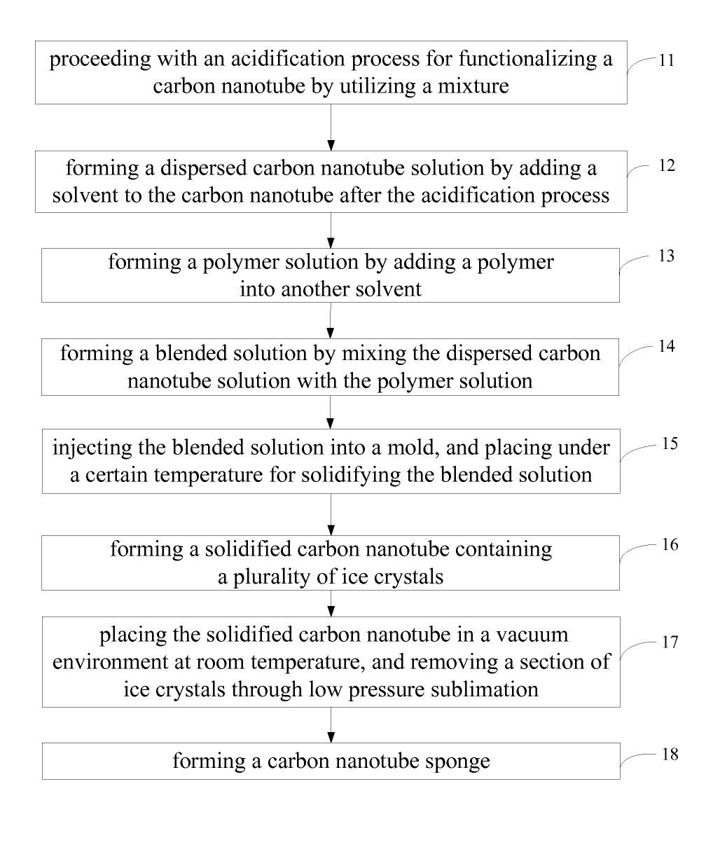

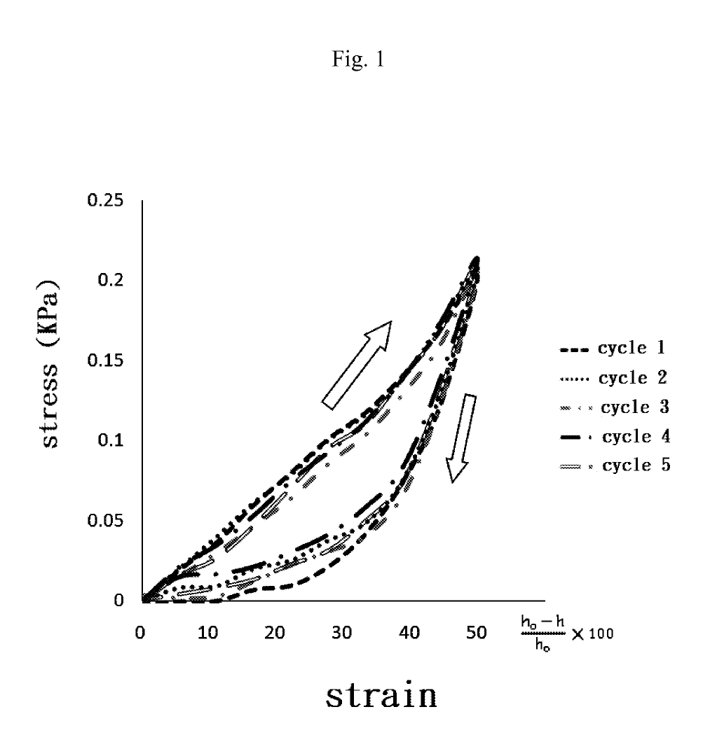

Please refer to FIG. 1, which is a production flow chart showing one embodiment of the present invention. A mixture is used with a carbon nanotube to proceed with a functional acidification process 11, sulfuric acid and nitric acid are used as the mixture in this embodiment, which proceeds with an acidification process for functionalizing the multi-walled or single-walled carbon nanotube to convert a hydrophobic into a hydrophilic through bonding the functional group (—COOH); thereafter, forming a dispersed carbon nanotube solution by adding a solvent to the carbon nanotube after the acidification process 12; at the same time, evenly mixing the dispersed carbon nanotube solution with mechanical force; then, forming a polymer solution by adding a polymer into another solvent 13, this polymer solution having a concentration of between 0% and 1%, then, forming a blended solution by mixing the dispersed carbon nanotube solution with the polymer solution 14 by mechanical stirring, and maintaining the carbon nanotube in the blended solution at a percentage of weight of 1-40 mg/mL; then injecting the blended solution into a mold, and placing under a certain temperature for solidifying the blended solution 15; the carbon nanotubes originally dispersed in the solvent will be pushed out as the ice crystals solidify and carbon nanotube films will form between the ice crystals, forming a solidified carbon nanotube containing a plurality of ice crystals 16.

In addition, different freezing rates have different results, in the case of a fast cooling rate the diameter of the ice particles becomes smaller and a porous carbon nanotube structure with a smaller pore size will be obtained after the completion of the steps, and in the case of a slow cooling rate, porous carbon nanotube structure with a larger pore size will be obtained; placing the solidified carbon nanotube in a vacuum environment at room temperature, and removing a section of ice crystals through low pressure sublimation 17; and forming a carbon nanotube sponge 18, the carbon nanotube sponge also known as CNT aerogels, wherein the carbon nanotube sponge has a multi-porous structure, and hole sizes of the carbon nanotube sponge can be controlled through adjusting the concentration of the dispersed carbon nanotube solution and the solidification rate of the blended solution, and the strength and stiffness of the carbon nanotube can be controlled through the density of the carbon nanotube and the addition of a polymer.

Please refer to Annex 1, which is a diagram showing carbon nanotube sponge of one embodiment of the invention. In this series of embodiments, it is cooled down to under 255K, and 0.1% of polymer materials is added so as to form the bulk material The carbon nanotubes are composed of carbon atoms. Compared with other carbon allotropes such as diamond and activated carbon, the carbon nanotubes are like curled graphene joined to a concentric columnar structure, which have both a single layer and multiple layers.

Because the surface of carbon nanotubes is composed of carbon-carbon covalent bond sp²-sp³ ,which has a very high theoretical strength (tensile strength˜100 Gpa) and a low density (1.8 g/cm³), so the carbon nanotubes have excellent high strength—weight ratio.

Taking advantages of high tensile strength of the carbon nanotubes, the carbon nanotubes can mix with other substrate to form a composite material that can be used in the aerospace, automotive, or construction industry.

When the porous structure of carbon nanotubes is produced, its density is only 3˜40 mg/mL (air is about 1.293 mg/mL), and the structure image under the electron microscope at 200× magnification is as shown in Annex 2, and can effectively reduce the weight burden in practical application.

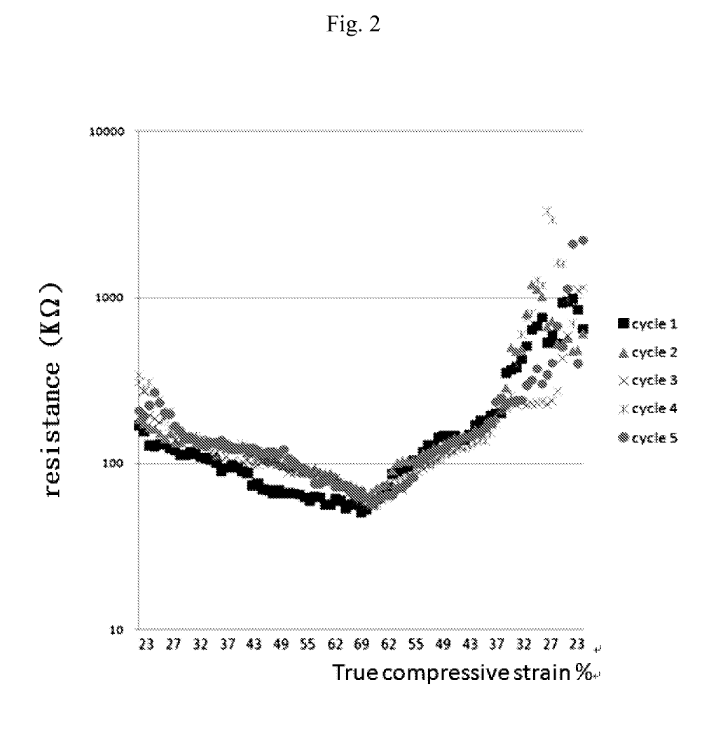

Please refer to FIG. 2, which is a diagram showing one embodiment of the carbon nanotube sponge of this invention which passes through 5 repeated compressions, and shows a data map of the returned mechanical property tests, the horizontal axis represents the compressive strain rate, the vertical axis represents the applied pressure.

Previous conventional technique shows that producing carbon nanotube aerogels required expensive supercritical fluid equipment and a longer manufacturing time.

The proposed method of this invention is using simpler production method and equipment, and without the need to add a dispersing agent to disperse the carbon nanotubes. For example, the dispersant, alkyl sulfonate, has the effect of increasing the resistance of the carbon nanotube aerogels, additionally, the dried dispersant itself is a friable powder and cannot strengthen the carbon nanotube aerogels, therefore, this present invention proposes a production method without dispersant for improvement, and significantly reduces the manufacturing cost and time by using the vacuum extraction method to remove the solvent.

Compared with general silica aerogels which are fragile and unable to be flexed, the carbon nanotube aerogels have wider applications for products, and the mechanical properties are shown as in FIG. 2.

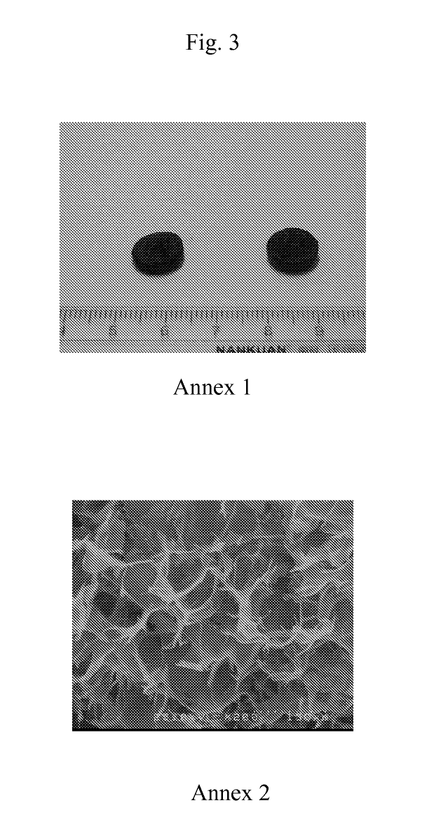

Please refer to FIG. 3 which is a diagram showing one embodiment of the carbon nanotube sponge of this invention which passes through 5 repeated compressions, and shows a data map of the electrical resistance value changes obtained.

The horizontal axis represents the compressive strain rate and the vertical axis represents the measured resistance value. Compared with those general silica aerogels, the carbon nanotube sponge is a multi porous bulk material with conductive properties, as the bulk material is compressed, it increases the contact points by making the carbon nanotubes overlap closer to each other, allowing for an increased internal conduction channel, and which results in a significant decline in the overall resistance. The overall structure of the carbon nanotube sponge is easily deformed by a minimal stress, so it can be used to produce sensitive pressure or displacement measuring sensors, moreover it has a high resolution, and the relationship between electrical resistance and strain is shown in FIG. 3.

In summary, the present invention proposes a method of producing carbon nanotubes sponge, which not only solves the problems which exist in the conventional technique, but also obtains better carbon nanotube sponge with increased flexibility and uniform holes. Since the carbon nanotubes are the current emerging nano-materials, and the current market demand is increasing, achieving a production process which is simplified and cost-saving, meets the requirements of the market and has many commercial applications.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method of producing carbon nanotube sponge, comprising the following steps:
(a) proceeding with an acidification process for functionalizing a carbon nanotube by utilizing a mixture;
(b) forming a dispersed carbon nanotube solution by adding a solvent to the carbon nanotube after the acidification process;
(c) forming a polymer solution by adding a polymer into another solvent;
(d) forming a blended solution by mixing the dispersed carbon nanotube solution with the polymer solution;
(e) injecting the blended solution into a mold, and placing under a certain temperature for solidifying the blended solution;
(f) forming a solidified carbon nanotube containing a plurality of ice crystals;
(g) placing the solidified carbon nanotube in a vacuum environment at room temperature, and removing a section of ice crystals through low pressure sublimation; and
(h) forming a carbon nanotube sponge,
wherein the carbon nanotube sponge has a multi-porous structure, and hole sizes of the carbon nanotube sponge can be controlled through adjusting a concentration of the dispersed carbon nanotube solution, a solidification rate of the blended solution and a crystallization temperature of the plurality of ice crystals, and a strength and stiffness of the carbon nanotube can be controlled through a density of the carbon nanotube and an addition of the polymer.

2. The method of claim 1, wherein the mixed solution in step (a) further comprises sulfuric acid and nitric acid.

3. The method of claim 1, wherein the carbon nanotube in step (a) is one selected from the following groups: single-walled carbon nanotube and multi-walled carbon nanotube.

4. The method of claim 1, wherein the solvent in step (c) is toluene.

5. The method of claim 1, wherein a concentration of the polymer solution in step (c) is between 0% and 1%.

6. The method of claim 1, wherein the carbon nanotube in the blended solution in step (d) occupies a percentage by weight of 1-40 mg/mL.

7. The method of claim 1, wherein the vacuum environment in step (g) is under 0.5 atm.
